(19) United States
(12) Patent Application Publication
(10) Pub. No.: US 2021/0047127 A1
(43) Pub. Date: Feb. 18, 2021

(54) CONVEYOR INSTALLATION WITH A RADIO SYSTEM

(71) Applicant: FERAG AG, Hinwil (CH)

(72) Inventor: Uwe GROTH, Wernetshausen (CH)

(73) Assignee: FERAG AG, Hinwil (CH)

(21) Appl. No.: 16/641,071

(22) PCT Filed: Aug. 27, 2018
(86) PCT No.: PCT/EP2018/072979

§ 371 Date: Feb. 21, 2020

(30) Foreign Application Priority Data
Sep. 4, 2017 (CH) 01098/17

(51) Int. Cl. B65G 17/48; B65G 17/36; B65G 47/64; B65G 47/34; G01S 1/02

(52) U.S. Cl. CPC B65G 17/485; B65G 17/36; B65G 47/64; B65G 1/1373; G01S 1/02; B65G 2203/0283; B65G 47/34

(57) ABSTRACT

A conveyor installation (100) includes conveyor sections (111), at least one switch (1111) for switching between the conveyor sections (111), a multiplicity of transportation units (110), which extend along the conveyor sections (111), a radio system (101) for spatially tracking the transportation units (110), and a control unit for controlling the conveyor system. (100), the radio system (101) including radio modules (1013) each assigned to a transportation unit (110) and at least one stationary radio device (1011), which are configured for exchanging radio signals, and a processing unit (109), wherein the processing unit (109) is configured to process the radio signals from the radio signals, and the current position of the transportation units (110) along the conveyor sections (111).

### BACKGROUND OF THE INVENTION

### Field of the Invention

The present invention relates to a conveyor installation having a plurality of transportation units and a radio system for spatially tracking the transportation units, as well as a radio system and a method for spatially tracking transportation units of a conveyor installation.

### Discussion of Related Art

With the increasing amount of transported goods being conveyed and the complexity and increasing cost pressures in the logistics sector, the requirements in terms of flexibility and the reduction of error rates in the conveyance of goods are increasing. In particular in the field of intralogistics, transported goods must often be conveyed at high speed, wherein the transportation goods undergo various processes such as order-picking, sorting, temporary storage, provisioning, etc.

In this context, the transported goods are conveyed by means of suitable conveyors, such as overhead gravity conveyors, chain conveyors or conveyor belts, and typically using transportation units, which may comprise grippers, bags or containers. In order to minimize the error rate in the conveyance of transported goods and to be able to respond flexibly to changing conveying conditions, such as a change in capacity, or changes in the transported goods of a flow of goods etc., it is desirable to provide a spatial tracking of the transportation units.

Tracking of transportation units with clamps in a chain conveyor is disclosed in WO2008/144945 A1. In the method described there, a transportation device has a plurality of clamps, which are arranged in a row one behind another and can be moved along a transport path with the aid of a continuous transport chain and are configured for holding similar products in a detachable manner, in particular printed products such as newspapers or the like. Contract-free read-in and/or read-out tags are arranged on the clamps. To read specified amounts of data in and/or out, in the tags of a clamp a transmission device which interacts with the transportation device is provided with at least one read-in/read-out device, which read-in/read-out device is moved into the vicinity of the respective clamp by means of the transmission device and can be moved over the selected section of the transport path together with the respective clamp. Tags in the form of RFIDs are preferably used, the read-in/read-out device being configured in such a way and/or moved in such a way that the one or more tags of a clamp can be read in or out undisturbed by the adjacent clamps. Such a crosstalk between multiple clamps is prevented by the fact that the antenna of the read-in/read-out device is brought sufficiently close to the tag of the desired clamp and at the same time, held sufficiently far away from the adjacent clamps. For this reason, it is necessary to provide a sufficient number of read-in/read-out devices, which have a specific arrangement near to the desired clamps or are moved along with them, in order to obtain a tracking with an adequate spatial resolution.

### SUMMARY OF THE INVENTION

In conveyor installations by means of which transportation goods are processed, it is desirable to provide a high conveying capacity and to minimize the error rate. A spatial tracking of the transportation units, which, for example can detect incorrect conveying operations, should be simple, reliable and flexible. This is especially the case for conveyor installations, in which switches are used to branch off the transportation goods in a specific direction. The switches can be a source of error if a transportation unit does not pass over a switch in the manner intended.

It is an object of the invention, therefore, to provide a conveyor installation and a method which at least partially improves on the prior art with regard to the spatial tracking of transportation units conveyed in the conveyor installation.

This object is achieved by means of the features of the independent claim. Advantageous embodiments of the invention are given in the dependent claims, in the present description and the figures.

The invention relates to a conveyor installation comprising conveyor sections, at least one switch for switching between the conveyor sections and a plurality of transportation units which can be conveyed along the conveyor sections. The conveyor installation also comprises a radio system for spatially tracking the transportation units, and a control unit for controlling the conveyor installation. The radio system comprises radio modules, which are each assigned to a transportation unit, and at least one stationary radio device, which are configured for exchanging radio signals, and a processing unit. The processing unit is configured to process the radio signals and to determine the current position of the transportation units along the conveyor sections from the radio signals.

The radio system offers the advantage that a continuous spatial tracking of transportation units is made possible by the fact that, by means of the radio system or the arrangement of the at least one stationary radio device, a coverage is obtained which advantageously extends over the entire conveyor installation or at least a part thereof, e.g. over a conveying device of the conveyor installation. In contrast to the prior art with readable RFID tags on the transportation units, the radio system requires no local readout devices which need to be located close to the transportation units or move along with them. The avoidance of local readout devices allows the amount of wiring to be reduced, which reduces costs and simplifies the maintenance of the conveyor installation. The radio system therefore offers the advantage of simplifying the construction of a device for spatially tracking the transportation units.

Preferably, the radio modules are each arranged on the transportation units. Alternatively or in addition, the radio modules can be arranged on transported goods which are conveyed by the transportation units. As a result, the radio modules advantageously move with the transportation units along the conveyor sections and enable the spatial tracking of the same. In the case where the radio modules are arranged on the transported goods, the radio system can be used for the spatial tracking of the transported goods. Advantageously, this allows a spatial tracking of the transported goods to be provided over the entire supply chain.

In one embodiment the radio modules are configured to be detachable. This offers the advantage that the radio modules can be attached at the desired location of a transportation unit and/or to the transported goods and removed again in a flexible manner.

The radio modules are preferably active radio modules, which offers the advantage of a large range.

In one embodiment the control unit is configured to store a path of the conveyor sections in the processing unit, and the processing unit is configured to determine the current position of the transportation units along the conveyor sections from the radio signals and on the basis of the stored path.

Usually, the current position of the transportation units is determined using methods of triangulation, multi-angulation, trilateration or multilateration. The known path of the conveyor sections thus offers the advantage that degrees of freedom can be eliminated in determining the current position of the transportation units, which are spatially bound to the conveyor sections. For example, for a switch-free, one-dimensional section of a conveyor section it may suffice if the stationary radio device comprises a single receiver, which receives a radio signal from a radio module of a transportation unit. The processing unit can then determine the current position of the transportation unit on the corresponding section of the conveyor section from this radio signal and on the basis of the stored path of the conveyor section. The processing unit preferably has a memory which the control unit can access and in which data can be saved, such as the path of the conveyor sections or defined trajectories.

In the context of the present invention a conveyor section is understood to mean a physical structure such as a rail, a conveyor belt, a pipe, a gutter or slide, or similar.

The conveyor installation is preferably an indoor installation. In particular, the radio system is advantageously configured to operate in frequency ranges and/or power ranges which are tailored to the indoor area. This offers the advantage that time-consuming approval procedures and/or adaptations to approval conditions can be avoided.

In one embodiment the control unit is configured to store a defined trajectory in the processing unit which depends on the respective position of the at least one switch, wherein the processing unit is configured, preferably downstream of a switch, to compare the current position of the transportation units along the conveyor sections with the stored, defined trajectory.

The defined trajectory at a specific position of a switch is intended to describe the intended path of a transportation unit within the path of the conveyor sections. In the case of a switch, the defined trajectory therefore describes, in particular, the intended direction in which a transportation unit should branch off at the switch. The radio system offers the advantage that the spatial tracking of the transportation units can be used to determine whether a transportation unit which passes over a switch branches off or is diverted in the intended direction. Erroneous branching of transportation units as a result of faults can thus be detected immediately after the switch.

The control unit can immediately respond to errors and, for example, redirect a corresponding switch or pause the conveying process. Depending on the position of a switch the control unit can store a new defined trajectory in the processing unit or update an already stored trajectory.

Preferably, the processing unit comprises a processor, which can calculate the current position of the transportation units from the radio signals and on the basis of the path of the conveyor sections which is stored in the memory. The processor can compare the current position of the transportation units with a stored, defined trajectory and if the position of a transportation unit deviates from the defined trajectory, can output an error message to an output device and/or input device, such as a GUI. The processor can also receive inputs from an installation operator via the input device and transfer them to the control unit.

In one embodiment the control unit is configured to control the position of the at least one switch. The control unit can comprise a radio control system for controlling the radio system. In addition, the control unit can comprise an installation control system for controlling the switch.

In one embodiment the control unit is integrated into the processing unit, which offers the advantage of a compact design.

In one embodiment, the radio modules each have a transmitter and the stationary radio device has at least one receiver, wherein the processing unit is connected to the stationary radio device.

The radio modules usually have an antenna which preferably actively generates electromagnetic waves and essentially radiates isotropically. A substantially isotropic radiation emission offers the advantage that the orientation of the transportation unit to which the radio module is assigned has little or no influence on the spatial tracking.

In the case of a one-dimensional conveyor section or a one-dimensional portion of the conveyor section a single receiver of the stationary radio device can be sufficient to determine the current position of a transportation unit along the conveyor section. The processing unit can process the radio signals of the radio modules relating to a distance between the transmitter and the receiver and determine the current position of the conveyor unit along the conveyor section on the basis of the stored route of the conveyor section.

Preferably, the radio modules are configured to transmit a radio signal with an identification of the respective transportation unit. The signal emitted by the radio module can contain different types of information relating to the radio module, which are modulated onto a carrier signal, wherein the information can comprise, in particular, the identification of the transportation unit to which the respective radio module is assigned. The identification of the respective transportation unit offers the advantage that using the radio system the plurality of transportation units can be spatially tracked simultaneously. For example, with the aid of the identification the current positions of the transportation units can be displayed simultaneously on an output device, in particular a GUI (Graphical User Interface), which is connected to the processing unit.

Preferably, the radio modules or the transmitters can emit the radio signal using the multiplexing method, in particular frequency-division multiplexing, time-division multiplexing or code multiplexing. Information can be optionally modulated onto the carrier signal, such as the time or intensity of the signal emission, which can then be used to determine the distance between transmitter and receiver.

In one embodiment the stationary radio device comprises at least two or at least three receivers.

An increase in the number of receivers in the stationary radio device offers the advantage that the accuracy of the spatial tracking can be increased. In the case of a switch with multiple branching points, multiple receivers of the stationary radio device can be used to increase the spatial resolution such that it can be determined with higher accuracy which branch the respective transportation unit has taken.

In one embodiment, the radio modules each have a receiver, wherein the processing unit is wirelessly connected to the radio modules. The radio system in this design can be implemented in particular as a GPS-like system.

The radio modules can either comprise transmitters or receivers. But they can also have transmitters and receivers at the same time, and advantageously act as transceivers.

In one variation the radio modules are grouped into zones, wherein the radio modules of each zone each have a transmitter and/or receiver, or a combination thereof.

In one embodiment the control unit is configured to enable and/or disable radio modules selectively.

The control unit is preferably wirelessly connected to the radio modules in order to control the radio modules. In particular, the control unit can selectively enable and/or disable transmitters and/or receivers of the radio modules. The control unit can selectively enable and/or disable one radio module or multiple radio modules.

For example, a radio module of a transportation unit which is at a standstill before a switch can be enabled by the control unit in such a way that this radio module, together with the stationary radio device, can carry out the determination of the current position of a transportation unit which has passed through the switch.

In the case where the radio module comprises a receiver, the control unit can enable, for example, the receiver of a radio module in front of the switch.

This receiver, in combination with a receiver or receivers of the stationary radio device, can carry out a position determination from the radio signal of a transmitter of a radio module which is assigned to a transportation unit which has passed through the switch.

Alternatively or in addition, the processing unit can be configured to selectively process radio signals from radio modules of the transportation units in order to determine the current position of a transportation unit.

The processing unit can, for example, process the radio signal which has been received from a radio module of a transportation unit before a switch in order to determine the current position of a transportation unit which has passed through the switch and emitted the radio signal.

The radio system therefore offers the advantage of a flexible, dynamic spatial tracking of transportation units within the conveyor installation.

In one embodiment the stationary radio device comprises at least one transmitter.

Information can be modulated onto the emitted carrier signal of the transmitter of the stationary radio device. For example, the information can contain the time of the emitted radio signal, or the intensity. By measuring distances to the transmitters the processing unit can be used to determine the position of a receiver of a radio module or the transportation unit.

In one embodiment the radio modules each comprise an energy store for supplying the energy to the radio module.

The energy stores can be rechargeable batteries.

In one embodiment, the radio modules each have a display device for displaying the charging state of the energy store. Optionally, the display device can display the condition of the energy store, e.g. in the event of a defect.

In embodiments in which the radio modules have transmitters, the transmitter can be configured to transmit the charging state of the energy store.

If the charging state of an energy store of a radio module falls below a certain threshold, the corresponding transportation unit can be rejected and transported to a charging device or into a charging section. By means of the charging device or in the charging section, the energy storage of the radio module can be recharged.

In one embodiment the conveyor installation comprises a discharge station for actively discharging transportation units with radio modules with an empty or defective energy store. The discharged transportation units can be fed to a charging device or a charging section.

In one embodiment the energy store is inductively rechargeable and the conveyor installation has an inductive charging device.

Preferably, the inductive charging device is arranged on a buffer section, in which the transportation units are at rest or only move at a slow speed. In particular, a plurality of inductive charging devices can be arranged on the conveyor section, at which the energy store can be inductively recharged.

In one embodiment the conveyor installation has a conveyor device, and the radio modules are configured to adjust the respective radio signal to the conveyor device in such a way that the spatial resolution of the radio system is modified in the region of the conveyor device.

Usually, the same spatial resolution is not required for all areas of the conveyor installation. For example, in the area of a sorting device with many switches a higher spatial resolution may be desired than in a buffer device or in a storage device, in which it only needs to be known that the transportation units are located in the buffer device or in the storage device. The spatial tracking of the transportation units is particularly important in the area of switches, because usually the majority of errors occur at the switches. The at least one stationary radio device in one design can therefore be arranged near to switches in case a spatial tracking of the transportation units is desired and/or sufficient in this area of the conveyor installation. By means of a suitable arrangement of the at least one stationary radio device, the spatial tracking of the transportation units can therefore be concentrated on specific areas of the conveyor installation in a flexible manner.

In one embodiment the radio modules emit radio signals in the form of burst signals. In such an embodiment, for example, in the area of a conveyor device in which a high spatial resolution is desired, the time between transmission bursts of the radio modules can be reduced. On the other hand, in an area in which a high spatial resolution is not required, the time between transmission bursts can be increased. Alternatively or in addition, in the area of a conveyor device in which a high spatial resolution is desired the control unit can selectively enable radio modules which interact with the stationary radio device and can increase the spatial resolution. Optionally, in conveyor devices for which a high spatial resolution is required, additional transmitters and/or receivers of the stationary radio device can be arranged and assigned to the respective conveyor device. In areas of the conveyor system in which there is no requirement for a high spatial resolution, such as on straight sections of a track without switches, in one design the control unit can selectively disable radio modules. This offers the advantage that energy for the operation of the radio modules can be saved. Configuring the conveyor installation with transportation units bound to conveyor sections therefore advantageously allows a flexible adaptation of the spatial resolution without impairing the spatial tracking of the transportation units.

The conveyor device can be a filling device, a sorting device, a buffer device, a storage device, an order-picking device or an extraction device.

In one configuration the conveyor installation is an overhead conveyor installation.

Particularly in the case of gravity-driven overhead conveyors, in many portions of the conveyor sections high conveying speeds may occur which can lead to faults in switches, for example, in combination with oscillatory movements of the transported goods, so that a continuous spatial tracking of the transportation units by the radio system is advantageous.

In one design the transportation units each comprise a bag for receiving the transported goods.

The transportation units can also comprise hooks, containers, buckets, grippers, trays, shovels, bowls, transport frames, or the like.

In one embodiment the radio modules are arranged on the bags or held by the bags. The advantage of this is that the bags can continue to be spatially tracked even when they are decoupled from the transportation units, e.g. during transfer processes.

In one embodiment the conveyor installation comprises a track and the transportation units each comprise movable carriages on the track with variable distance relative to each other.

In one embodiment the radio modules are each arranged on the carriage or on a cargo being conveyed with the carriage. This offers the advantage of increased reliability in the spatial tracking of the transportation units, as the carriages are exposed to fewer faults, for example due to oscillatory movements.

In one embodiment the conveyor installation comprises a conveyor belt. In embodiments in which the conveyor section comprises a conveyor belt, the transportation units preferably each comprise a container, a bucket, a bowl, a tray, a basket or similar device which can hold transported goods.

The invention also relates to a radio system for the spatial tracking of transportation units of a conveyor installation in accordance with this description, wherein the radio system comprises radio modules, which are each assigned to a transportation unit, and at least one stationary device, which are configured for the exchange of radio signals, and a processing unit. The processing unit is configured to process the radio signals and to determine the current position of the transportation units along conveyor sections of the conveyor installation from the radio signals.

In one embodiment of the radio system in the processing unit a path of the conveyor sections is storable, and the processing unit is configured to determine the current position of the transportation units along conveyor sections of the conveyor installation from the radio signals and on the basis of the stored path.

The invention also relates to a method for spatially tracking transportation units of a conveyor installation in accordance with the above description, the method comprising: i) providing a radio system comprising radio modules, which are each assigned to a transportation unit, and at least one stationary radio device, ii) providing a control unit for controlling the conveyor installation, iii) exchanging radio signals between the radio modules and the stationary radio device, iv) providing a processing unit, v) processing the radio signals by means of the processing unit, vi) determining the current position of the transportation units along the conveyor sections from the radio signals.

In one embodiment of the method, the method further comprises the steps of: a) storing a path of the conveyor sections in the processing unit by means of the control unit, b) determining the current position of the transportation units along the conveyor sections from the radio signals and on the basis of the stored path.

### BRIEF DESCRIPTION OF SEVERAL VIEWS OF THE DRAWINGS

Embodiments of the invention will be described in more detail by reference to the following schematic drawings and the associated description. Shown are:

FIG. 1 shows a perspective view of an embodiment of a transportation unit and a radio module arranged on the transportation unit;

FIG. 2 shows a perspective view of an embodiment of a transportation unit and a radio module arranged on a product;

FIG. 3 shows a schematic drawing of an embodiment of a conveyor installation;

FIG. 4 shows a block diagram with the processing unit of FIG. 3;

FIG. 5 shows a side view of an embodiment of a storage device;

FIG. 6 shows a perspective view of an embodiment of an extraction device;

FIG. 7 shows a perspective view of a further embodiment of a storage device;

FIG. 8 shows a side view of a detail of another embodiment of a conveyor installation.

### DETAILED DESCRIPTION OF THE INVENTION

In order to illustrate the invention, preferred embodiments will be described in more detail with reference to the figures.

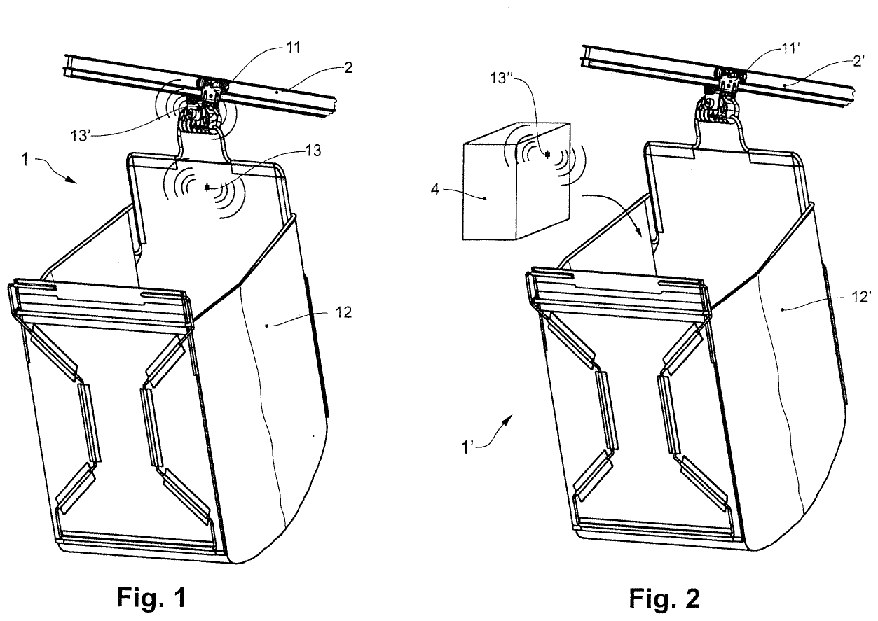

FIG. 1 shows an embodiment of a transportation unit 1 with a carriage 11 and a bag 12. The carriage 11 can be conveyed in a track 2 of a conveyor device. On one wall of the bag 12 a radio module 13 is arranged. The radio module 13 comprises a transmitter and emits radio signals. The radio signals are preferably in the GHz range. For illustration purposes FIG. 1 shows a radio module 13′ which is arranged on the carriage 11. In general, however, the transportation unit 1 has a single radio module, which is arranged either on the bag 12 or on the carriage 11. The radio module 13 or 13′ has a rechargeable battery, which can be recharged and supplies the radio module 13 or 13′ with energy. FIG. 2 shows an embodiment of a transportation unit 1′ with a carriage 11′ and a bag 12′. The carriage 11′ can be conveyed in a rail 2′ of a conveyor device. A product 4 is also shown, on which a radio module 13″ is arranged. Once the product 4 has been collected in the bag 12′ the radio module 13″ is assigned to the transportation unit 1′, so that the transportation unit 1′ can be spatially tracked by means of the radio module 13″. The product 4 can also be spatially tracked before collection in the bag 12′ and after removal from the bag 12′, so that a spatial tracking of the product 4 is enabled across the entire supply chain.

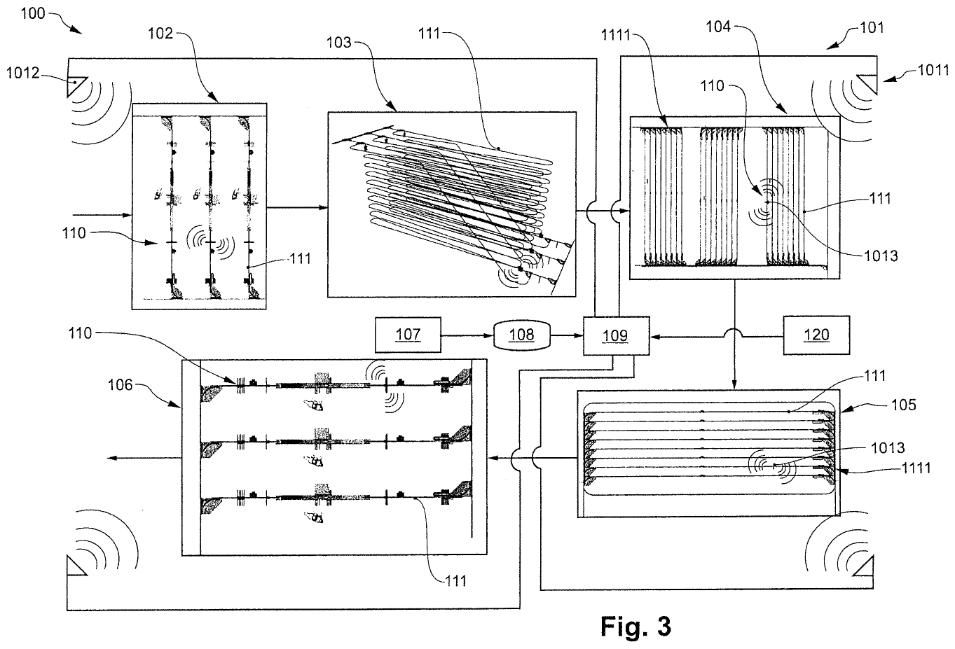

FIG. 3 shows a schematic drawing of an embodiment of a conveyor installation configured as an overhead conveyor installation 100 with a plurality of transportation units 110 which are bound to conveyor sections configured as tracks 111 and can be conveyed along the tracks 111. The transportation units 110 comprise carriages which can be moved on the tracks 111 with variable distance relative to each other, and bags for holding transported goods. The overhead conveyor installation 100 comprises a radio system 101 for spatially tracking the transportation units 110.

The radio system comprises a stationary radio device 1011 with four antennas 1012, which receive radio signals from radio modules 1013 which are arranged on the transportation units 110. The radio modules 1013 have active transmitters which generate and emit radio signals. The radio signals emitted by the radio modules 1013 contain an identification, which allows a differentiation between the transportation units 110. In FIG. 3, for the sake of clarity the radio signals are only shown symbolically on some representative transportation units and on the antennas 1012.

The overhead conveyor installation 100 comprises the following conveyor devices: a filling device 102, in which the bags of the transportation units 110 are filled with transported goods, a storage device 103, a sorting device 104, a supplying device 105, in which a pre-sorted supply is performed, and an extraction device 106, from which the goods are removed for dispatch. The transportation units with empty bags issued from the extraction device 106 are stored in an empty storage device (not shown in FIG. 3), before they can be fed back to the filling device 102. In an ERP (Enterprise Resource Planning) system 107, an order is raised and fed to a goods flow computer 108, which calculates the course of the transported goods conveyed in the overhead conveyor installation 100. The goods flow computer 108 is connected to a processing unit 109, which receives and processes radio signals from the antennas 1012. The path of the conveyor sections 111 is stored in the processing unit 109. The processing unit 109 determines the current position of the transportation units 110 along the conveyor sections 111 from the received radio signals of the antennas 1012 and on the basis of the stored path of the conveyor sections 111. The overhead conveyor installation 100 has switches 1111 for switching between the conveyor sections 111, wherein a defined trajectory which depends on the respective switch position is stored in the processing unit 109. The processing unit 109 compares the current position of a transportation unit 110 which has passed a switch 1111 with the defined trajectory and determines whether the transportation unit 110 has taken the branch provided in the defined trajectory, corresponding to the switch position, at the corresponding switch 1111.

From FIG. 3 it can be seen that the four antennas 1012 of the stationary radio device 1011 are arranged peripherally at four corner points of the overhead conveyor installation 100 and thus enable a continuous spatial tracking of the transportation units 110 in the overhead conveyor installation 100. The differentiation of the transportation units 110 by means of the identification in the radio signals allows a simultaneous spatial tracking of the transportation units 110 that are moving in the overhead conveyor installation 100. The processing unit 109 is connected to a GUI 120, on which the current positions of the transportation units 110 can be displayed. A plant operator can monitor the overhead conveyor installation 100 and the transportation units 110 via the GUI 120 and intervene as required in the event of faults.

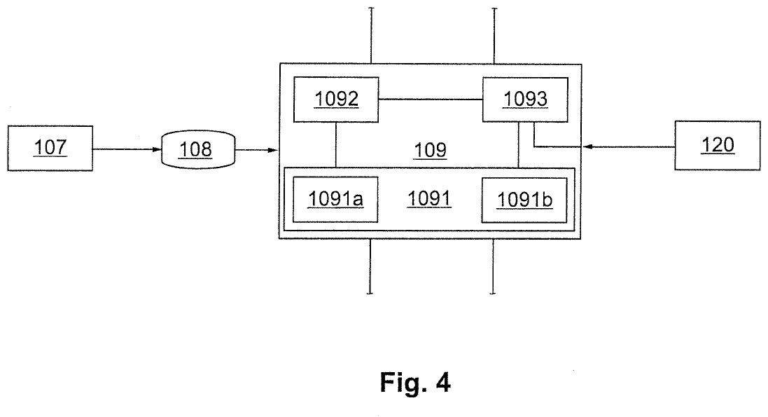

FIG. 4 shows a block diagram with the processing unit 109, the ERP system 107, the goods flow computer 108 and the GUI 120 of FIG. 3. In the embodiment shown in FIGS. 3 and 4 a control unit 1091 is integrated into the processing unit 109. The control unit 1091 comprises a radio control system 1091a for controlling the radio system, and an installation control system 1091b for controlling the switches. The processing unit 109 also comprises a memory 1092, in which the control unit 1091 can store the path of the conveyor sections and/or the defined trajectories. The processing unit 109 also comprises a processor 1093, which can calculate the current position of the transportation units from the radio signals and on the basis of the path of the conveyor sections, which is stored in the memory 1092. The processor 1093 compares the current position of the transportation units with a stored, defined trajectory and if the position of a transportation unit deviates from the defined trajectory, outputs an error message to the GUI 120. The processor 1093 can also receive inputs from an installation operator via the GUI 120 and transfer them to the control unit 1091.

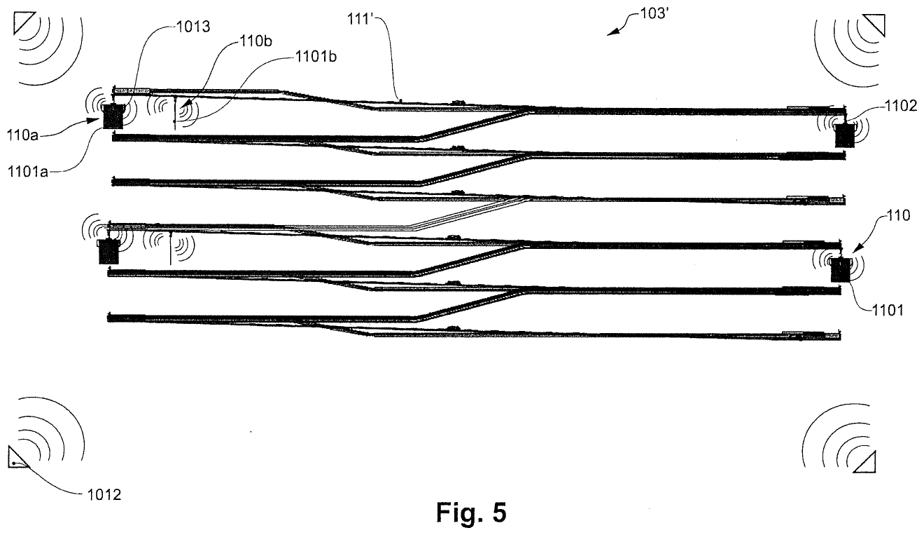

FIG. 5 shows a side view of an embodiment of a storage device 103′ with transportation units 110, 110a, 110b. The diagram shows four antennas 1012 of a radio system of the overhead conveyor installation and radio modules 1013, which are arranged on the bags 1101, 1101a, 1101b of the transportation units 110, 110a, 110b and comprise transmitters. The antennas 1012, as shown in FIG. 3, can be common antennas for the entire overhead conveyor installation, or antennas which are arranged specifically for the storage device 103′ and customized to the spatial resolution requirements of the storage device 103′. The transportation units 110, 110a, 110b comprise carriages 1102 which can be conveyed in a track 111′ with variable distance relative to each other. Due to the substantially isotropic radiation of the transmitters of the radio modules 1013, the influence of the orientation of the bags 1101, 1101a, 1101b on the accuracy of the determination of the current position of the radio modules 1013 or of the transportation units 110, 110a, 110b is minimal and typically negligible. FIG. 5 shows for illustration purposes two bags 1101a, 1101b, which are oriented at 9020 relative to each other.

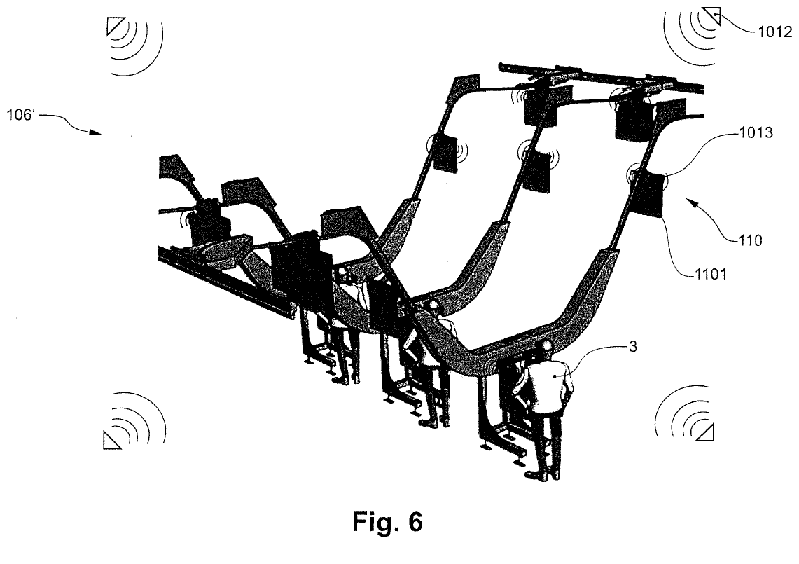

FIG. 6 shows a perspective view of an embodiment of an extraction device 106′. Four peripherally positioned antennas 1012 of a stationary radio device are shown schematically. Radio modules 1013 are arranged on the transportation units 110, which exchange radio signals with the antennas 1012. The transportation units 110 comprise bags 1101 in which transported goods are conveyed, which are removed by people 3 in the extraction device 106′ for dispatch, for example.

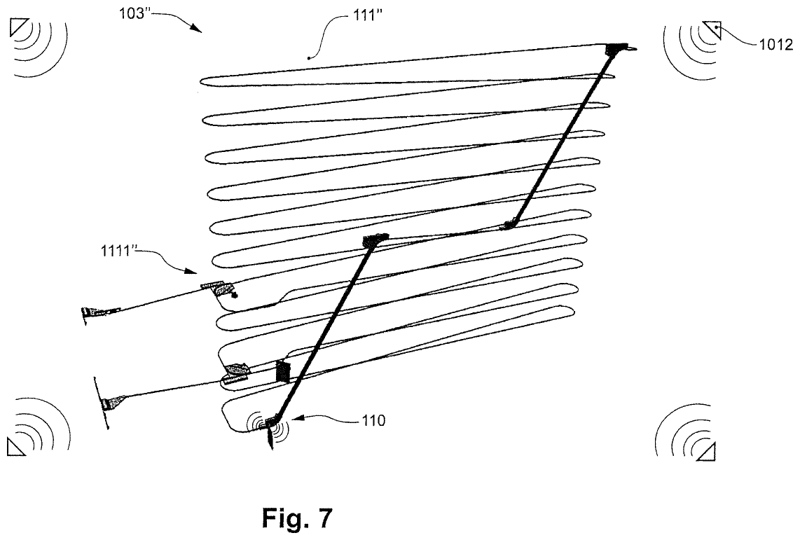

FIG. 7 shows a further embodiment of a storage device 103″ of an overhead conveyor installation. Transportation units 110 with radio modules are conveyed in the storage device 103″ in a track 111″. The storage device 103″ comprises switches 1111″ by means of which the transportation units 110 can branch off depending on the switch position. The radio system with the antennas 1012 and the radio modules of the transportation units 110 determine whether the transportation units 110 have taken the intended branch.

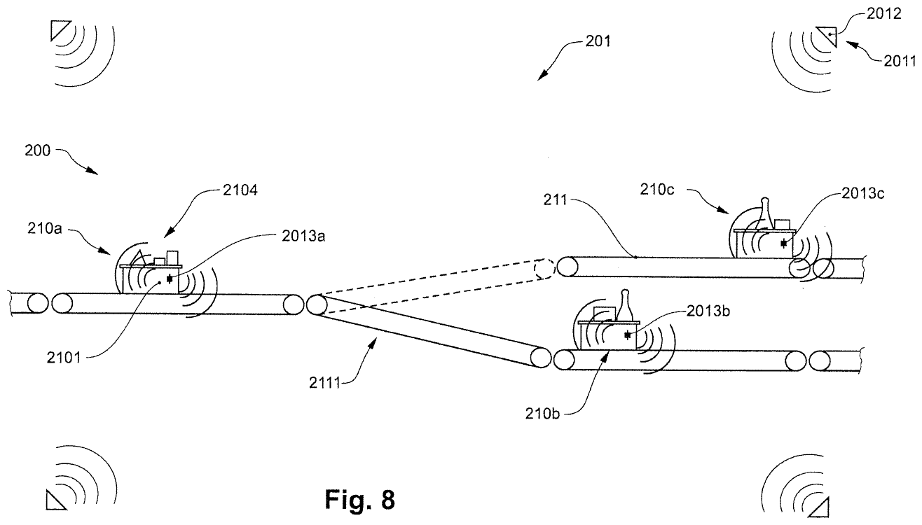

FIG. 8 shows a detail of another embodiment of a conveyor installation, which is configured as a belt conveyor installation. In the detail in FIG. 6 a belt conveyor 200 of the belt conveyor installation is shown. The belt conveyer 200 comprises a conveyor belt 211, on which transportation units 210a, 210b, 210c are conveyed. The transportation units 210a, 210b, 210c comprise containers 2101, in which transportation goods 2104 are carried. On each of the containers 2101 radio modules 2013a, 2013b, 2013c are arranged, which comprise transmitters and receivers. The belt conveyor installation comprises a radio system 201, which comprises the radio modules 2013a, 2013b, 2013c and a stationary radio device 2011 with four antennas 2012. The antennas 2012 comprise receivers which receive radio signals of the transmitters of the radio modules 2013a, 2013b, 2013c. The belt conveyor 200 comprises a switch 2111, by means of which the transportation units 210a, 210b, 210c can be branched off. In the configuration shown, the radio module 2013a of the transportation unit 210a, which is located before the switch 2111, can be used as an additional receiver in order to determine, together with the receivers of the stationary radio device 2011, the current position of the transportation units 210b, 210c behind the switch with higher accuracy.

1. A conveyor installation (100, 200) comprising:
conveyor sections (2, 111, 111′, 111″, 211),
at least one switch (1111, 1111″, 2111) for switching between the conveyor sections (2, 111, 111′, 111″, 211),
a multiplicity of transportation units (1, 1′, 110, 110a, 110b, 210a, 210b, 210c) which can be conveyed along the conveyor sections (2, 111, 111′, 111″, 211),
a control unit (1091, 1091a, 1091b) for controlling the conveyor installation (100, 200), and
a radio system (101, 201) for spatially tracking the transportation units (1, 1′, 110, 110a, 110b, 210a, 210b, 210c), wherein the radio system (101, 201) includes radio modules (13, 13′, 1013, 2013a, 2013b, 2013c), which are each assigned to a transportation unit (1, 1′, 110, 110a, 110b, 210a, 210b, 210c), and at least one stationary radio device (1011, 2011) which are configured to exchange radio signals, and a processing unit (109), wherein the processing unit (109) is configured to process the radio signals and to determine a current position of the transportation units (1, 1′, 110, 110a, 110b, 210a, 210b, 210c) along the conveyor sections (2, 111, 111′, 111″, 211) from the radio signals.

2. The conveyor installation (100, 200) as claimed in claim 1, wherein the control unit (1091) is configured to store a path of the conveyor sections (2, 111, 111′, 111″, 211) in the processing unit (109), and the processing unit (109) is configured to determine the current position of the transportation units (1, 1′, 110, 110a, 110b, 210a, 210b, 210c) along the conveyor sections (2, 111, 111′, 111″, 211) from the radio signals and on the basis of the stored path.

3. The conveyor installation (100, 200) as claimed in claim 1, wherein the control unit (1091) is configured to store a defined trajectory dependent on the respective position of the at least one switch (1111, 1111″, 2111) in the processing unit (109), wherein the processing unit (109) is configured to compare, preferably downstream of a switch (1111, 1111″, 2111), the current position of the transportation units (1, 1′, 110, 110a, 110b, 210a, 210b, 210c) along the conveyor sections (2, 111, 111′, 111″, 211) with the stored defined trajectory.

4. The conveyor installation (100, 200) as claimed in claim 1, wherein the control unit (1091, 1091b) is configured to control the position of the at least one switch (1111, 1111″, 2111).

5. The conveyor installation (100, 200) as claimed in claim 1, wherein the radio modules (13, 13′, 13″, 1013, 2013a, 2013b, 2013c) each comprise a transmitter and the stationary radio device (1011, 2011) comprises at least one receiver (1012, 2012), wherein the processing unit (109) is connected to the stationary radio device (1011, 2011).

6. The conveyor installation (100, 200) as claimed in claim 1, wherein the radio modules (13, 13′, 13″, 1013, 2013a, 2013b, 2013c) are configured to send a radio signal with an identification of the respective transportation unit (1, 1′, 110, 110a, 110b, 210a, 210b, 210c).

7. The conveyor installation (100, 200) as claimed in claim 1, wherein the radio modules (13, 13′, 13″, 1013, 2013a, 2013b, 2013c) each comprise a receiver, wherein the processing unit is wirelessly connected to the radio modules (13, 13′, 13″, 1013, 2013a, 2013b, 2013c).

8. The conveyor installation (100, 200) as claimed in claim 1, wherein the control unit (1091, 1091a ) is configured to selectively enable and/or disable radio modules (13, 13′, 13″, 1013, 2013a, 2013b, 2013c).

9. The conveyor installation (100, 200) as claimed in claim 1, wherein in order to determine the current position of a transportation unit (1, 1′, 110, 110a, 110b, 210a, 210b, 210c), the processing unit (109) is configured to selectively process radio signals from radio modules (13, 13′, 13″, 1013, 2013a, 2013b, 2013c) of the transportation units (1, 1′, 110, 110a, 110b, 210a, 210b, 210c).

10. The conveyor installation (100, 200) as claimed in claim 1, wherein the stationary radio device (1011, 2011) comprises at least one transmitter.

11. The conveyor installation as claimed in claim 1, wherein the radio modules (13, 13′) each include an energy store for supplying power to the radio module (13, 13′).

12. The conveyor installation as claimed in claim 11, wherein the energy store can be inductively charged and the conveyor installation comprises an inductive charging device.

13. The conveyor installation as claimed in claim 11 wherein the conveyor installation comprises a discharge station for actively discharging transportation units with radio modules with an empty or defective energy store.

14. The conveyor installation (100) as claimed in claim 1, wherein the conveyor installation (100, 200) comprises at least one conveyor device (102, 103, 103′, 103″, 104, 105, 106, 106′), and the radio modules (13, 13′, 13″, 1013, 2013a, 2013b, 2013c) are configured to adjust the respective radio signal to the conveyor device (102, 103, 103′, 103″, 104, 105, 106, 106′) in such a way that the spatial resolution of the radio system (101, 201) in the area of the conveyor device (102, 103, 103′, 103″, 104, 105, 106, 106′) is modified.

15. The conveyor installation (100) as claimed in claim 14, wherein the conveyor device is a filling device (102), a sorting device (104, 105), a buffer device, a storage device (103, 103′, 103″), an order-picking device or an extraction device (106, 106′).

16. The conveyor installation (100) as claimed in claim 1, wherein the conveyor installation (100) is an overhead conveyor installation.

17. The conveyor installation (100) as claimed in claim 1, wherein the transportation units (1, 1′, 110, 110a, 110b each comprise a bag (12, 12′, 1101, 1101a, 1101b for receiving transported goods.

18. The conveyor installation (100) as claimed in claim 17, wherein the radio modules (13, 1013) are each arranged on the bags (12, 1101, 1101a, 1101b) or held by the bags.

19. The conveyor installation (100) as claimed in claim 1, wherein the conveyor section includes a track (2, 2′, 111, 111′, 111″) and the transportation units (1, 1′, 110, 110a, 110b) each comprise moveable carriages (11, 11′, 1102) with variable distance relative to each other on the track (2, 2′, 111, 111′, 111″).

20. The conveyor installation (100) as claimed in claim 19, wherein the radio modules (13′) are each arranged on the carriage (11) or on a transported good being conveyed with the carriage.

21. A radio system (101, 201) for spatially tracking transportation units (1, 1′, 110, 110a, 110b, 210a, 210b, 210c) of a conveyor installation (100, 200) as claimed in claim 1, the radio system (101, 201) comprises radio modules (13, 13′, 1013, 2013a, 2013b, 2013c), which are each assigned to a transportation unit (1, 1′ 110, 110a, 110b, 210a, 210b, 210c), and at least one stationary radio device (1011, 2011), which are configured to exchange radio signals, and a processing unit (109), wherein the processing unit (109) is configured to process the radio signals and to determine the current position of the transportation units (1, 1′, 110, 110a, 110b, 210a, 210b, 210c) along conveyor sections (2, 111, 111′, 111″, 211) of the conveyor installation (100, 200) from the radio signals.

22. The radio system (101, 201) as claimed in claim 21, wherein a path of the conveyor sections (2, 111, 111′, 111″, 211) is storable in the processing unit (109), and the processing unit (109) is configured to determine the current position of the transportation units (1, 1′, 110, 110a, 110b, 210a, 210b, 210c) along the conveyor sections (2, 111, 111′, 111″, 211) from the radio signals and on the basis of the stored path.

23. A method for the spatial tracking of transportation units (1, 1′, 110, 110a, 110b, 210a, 210b, 210c) of a conveyor installation (100, 200) as claimed in claim 1, comprising:
i) providing a radio system (101, 201) comprising radio modules (13, 13′, 1013, 2013a, 2013b, 2013c), which are each assigned to a transportation unit (1, 1′, 110, 110a, 110b, 210a, 210b, 210c), and at least one stationary radio device (1011, 2011),
ii) providing a control unit (1091, 1091a, 1091b) for controlling the conveyor installation (100, 200),
(iii) exchanging radio signals between the radio modules (13, 13′, 1013, 2013a, 2013b, 2013c) and the stationary radio device (1011, 2011),
iv) providing a processing unit (109),
v) processing the radio signals by means of the processing unit (109), and
(vi) determining the current position of the transportation units (1, 1′, 110, 110a, 110b, 210a, 210b, 210c) along the conveyor sections (2, 111, 111′, 111″, 211) from the radio signals.

24. The method as claimed in claim 23, further comprising the steps of:
a) storing a path of the conveyor sections (2, 111, 111′, 111″, 211) in the processing unit (109) by means of the control unit (1091, 1091a, 1091b),
b) determining the current position of the transportation units (1, 1′, 110, 110a, 110b, 210a, 210b, 210c) along the conveyor sections (2, 111, 111′, 111″, 211) from the radio signals and on the basis of the stored path.
